(19) United States
(12) Patent Application Publication
(10) Pub. No.: US 2025/0239668 A1
(43) Pub. Date: Jul. 24, 2025

(54) ELECTRICAL SYSTEMS INCLUDING MULTIPLE BATTERY CHEMISTRIES AND METHODS FOR OPERATING THE SAME

(71) Applicant: GM GLOBAL TECHNOLOGY OPERATIONS LLC, Detroit, MI (US)

(72) Inventors: Jian Yao, Shanghai (CN); Chengwu Duan, Shanghai (CN); Lei Hao, Troy, MI (US); Chunhao J. Lee, Troy, MI (US); Shuonan Xu, Troy, MI (US); Zhenwen Hu, Shanghai (CN); Thomas W. Nehl, Shelby Twp., MI (US)

(73) Assignee: GM GLOBAL TECHNOLOGY OPERATIONS LLC, Detroit, MI (US)

(21) Appl. No.: 18/610,758

(22) Filed: Mar. 20, 2024

(30) Foreign Application Priority Data
Jan. 19, 2024 (CN) 202410084222.X

(51) Int. Cl. H01M 10/44; B60L 50/60; B60L 53/62; H02J 7/00; H02J 7/34

(52) U.S. Cl. CPC H01M 10/441; B60L 50/60; B60L 53/62; H02J 7/00047; H02J 7/0063; H02J 7/00712; H02J 7/342; B60L 2210/10; H01M 2220/20; H02J 2207/20

(57) ABSTRACT

An electrical system includes a battery pack assembly that includes a first cell set and a second cell set. The first cell set includes a first battery chemistry and the second cell set includes a second battery chemistry that is different than the first battery chemistry. Switches selectively connect the first cell set and the second cell set in series with battery connection terminals. A DC-DC converter provides dynamic energy distribution between the first and second cell sets. A controller controls the switches and the DC-DC converter. The controller is configured to determine an operating strategy and places the first cell set, the second cell set, or both the first and second cell sets in electrical communication with the battery connection terminals in response to the operating strategy of the battery pack assembly.

### CROSS-REFERENCE TO RELATED APPLICATIONS

This application claims the benefit of priority to Chinese Patent Application CN202410084222.X filed on Jan. 19, 2024, which is hereby incorporated by reference in its entirety.

### INTRODUCTION

The present disclosure relates to energy or power storage and transfer, and more particularly to electrical systems including a battery pack assembly with multiple battery chemistries and methods for controlling operation of such systems.

Electrified powertrain systems of motor vehicles and other mobile electrical systems include an electrical storage and transfer system configured to energize one or more electric motors to generate motive torque. For example, an electric traction motor may be connected to the road wheels of an electric vehicle, with generated output torque being directed to the road wheels to propel the electric vehicle on a road surface.

A wide variety of rechargeable energy storage systems (RESSs) may be available for electrically powering a traction motor or other output device operable for converting electrical power to mechanical power for purposes of propelling, driving, or otherwise operating a vehicle. When in use, a RESS may experience degradation, efficiency decreases, slower charging and discharging performance, less capacity, and other types of possible performance limiting effects. It is desirable to provide systems and methods that can improve the performance of such systems.

### SUMMARY

An electrical system in accordance with one or more embodiments is provided. The electrical system includes a battery pack assembly. The battery pack assembly includes a first cell set having a first plurality of energy storage cells that include a first battery chemistry. A second cell set has a second plurality of energy storage cells that include a second battery chemistry that is different than the first battery chemistry. One or more switches are configured to selectively connect the first cell set and the second cell set in series with battery connection terminals for electrical communication therebetween. A DC-DC converter is connected to the first cell set and to the second cell set and is configured to provide dynamic energy distribution between the first and second cell sets. The electrical system further includes a controller that controls the one or more switches and the DC-DC converter. The controller is configured to determine an operating strategy of the battery pack assembly. The controller is further configured to place the first cell set, the second cell set, or both the first and second cell sets in electrical communication with the battery connection terminals in response to the operating strategy of the battery pack assembly.

In some embodiments, the first battery chemistry includes a high energy density battery chemistry, and the second battery chemistry includes a high charging and discharging rate battery chemistry.

In some embodiments, the high energy density battery chemistry includes a lithium ion battery chemistry that includes a cathode comprising nickel, cobalt, and manganese (NCM battery chemistry). The high charging and discharging rate battery chemistry includes a sodium ion battery chemistry (sodium battery chemistry).

In some embodiments, the one or more switches includes a first switch and a second switch that are positionally controlled by the controller and configured for electrical communication with the first and second cell sets. The first switch has a first switch A position and a second switch A position, and the second switch has a first switch B position and a second switch B position. When the controller positions the first switch in the first switch A position and the second switch in the first switch B position, the first cell set is in electrical communication with the battery connection terminals while the second cell set is disconnected from the battery connection terminals. When the controller positions the first switch in the first switch A position and the second switch in the second switch B position, the first cell set and the second cell set in series are in electrical communication with battery connection terminals. When the controller positions the first switch in the second switch A position and the second switch in the second switch B position, the second cell set is in electrical communication with the battery connection terminals while the first cell set is disconnected from the battery connection terminals.

In some embodiments, the first switch further has a switch A disconnect position and the second switch further has a switch B disconnect position. When the controller positions the first switch in the switch A disconnect position and the second switch in the switch B disconnect position, the battery pack assembly is disconnected from the battery connection terminals.

In some embodiments, the one or more switches include a first switch and a second switch that are positionally controlled by the controller and configured for electrical communication with the first cell set. The first switch has a first switch A position and a second switch A position, and the second switch has a first switch B position and a switch B disconnect position. When the controller positions the first switch in the first switch A position and the second switch in the switch B disconnect position, the first cell set and the second cell set in series are in electrical communication with battery connection terminals. When the controller positions the first switch in the second switch A position and the second switch in the first switch B position, the first cell set is in parallel and connected with the second cell set for electrical communication with the battery connection terminals.

In some embodiments, the operating strategy includes a relatively high energy state of charge (SOC) charging strategy for direct current fast charging (DCFC) for when the second cell set has a SOC at or above a predetermined SOC threshold. The relatively high energy SOC charging strategy includes DCFC the second cell set toward a nearly fully charged predetermined SOC threshold while the DC-DC converter distributes energy to the first cell set. If the second cell set reaches the nearly fully charged predetermined SOC threshold, then the first cell set is DCFC toward a fully charged SOC while the DC-DC converter distributes energy to the second cell set to charge both the first and second cell sets toward the fully SOC.

In some embodiments, the predetermined SOC threshold is from about 25% to about 35%, and the nearly fully charged predetermined SOC threshold is from about 94% to about 98%.

In some embodiments, the operating strategy includes a relatively low energy SOC charging strategy for when the second cell set has a SOC at or below a nearly zero predetermined SOC threshold. The relatively low energy SOC charging strategy includes DCFC the second cell set toward a nearly fully charged predetermined SOC threshold while the DC-DC converter distributes energy to the first cell set. If the second cell set reaches the nearly fully charged predetermined SOC threshold, then the first cell set is DCFC toward a fully charged SOC while the DC-DC converter distributes energy to the second cell set to charge both the first and second cell sets toward the fully charged SOC. Alternatively, the first and second cell sets are charged simultaneously toward the fully charged SOC without DCFC operation.

In some embodiments, the nearly zero predetermined SOC threshold is from about 0% to about 10%, and the nearly fully charged predetermined SOC threshold is from about 94% to about 98%.

In some embodiments, the operating strategy includes a relatively high SOC discharging strategy for when the second cell set has a SOC above a predetermined SOC threshold. The relatively high SOC discharging strategy includes discharging the first and second cell sets while the DC-DC converter distributes energy from the second cell set to the first cell set until the second cell set is at or below the predetermined SOC threshold. If the second cell set is at or below the predetermined SOC threshold, the first and second cell sets are discharged while the DC-DC converter distributes energy from the first cell set to the second cell set to fully discharge the first and second cell sets.

In some embodiments, the predetermined SOC threshold is from about 25% to about 35%.

In some embodiments, the operating strategy includes a relatively low temperature discharging strategy for when the battery pack assembly is at a predetermined low temperature threshold. The relatively low temperature discharging strategy includes discharging the second cell set while the first cell set is disconnected from the battery connection terminals and the DC-DC converter distributes energy to heat the first cell set to a temperature above the predetermined low temperature threshold. When the battery pack assembly is at or above the temperature above the predetermined low temperature threshold, the first and second cell sets are simultaneously discharging.

In some embodiments, the predetermined low temperature threshold is from about −35° C. to about −20° C.

In some embodiments, the operating strategy includes a relatively low DC voltage condition driving cycle discharging strategy that includes discharging the first cell set while the second cell set is disconnected from the battery connection terminals, or discharging the second cell set while the first cell set is disconnected from the battery connection terminals.

In some embodiments, the operating strategy includes a relatively high DC voltage condition driving cycle discharging strategy that includes discharging the first and second cell sets.

A method of operating the electrical system in accordance with one or more embodiments is provided. The method includes determining an operating strategy of a battery pack assembly. The battery pack assembly includes a first cell set having a first plurality of energy storage cells that include a first battery chemistry, and a second cell set having a second plurality of energy storage cells that include a second battery chemistry that is different than the first battery chemistry. The method further includes placing the first cell set, the second cell set, or both the first and second cell sets in series in electrical communication with battery connection terminals in response to the operating strategy of the battery pack assembly. Optionally, dynamic energy distribution is provided between the first and second cell sets in response to the operating strategy of the battery pack assembly.

A vehicle in accordance with one or more embodiments is provided. The vehicle includes an output device and an electrical system. The electrical system is configured to provide electrical energy to the output device. The electrical system includes a battery pack assembly. The battery pack assembly includes a first cell set having a first plurality of energy storage cells that include a first battery chemistry, and a second cell set having a second plurality of energy storage cells that include a second battery chemistry that is different than the first battery chemistry. One or more switches are configured to selectively connect the first cell set and the second cell set in series with battery connection terminals for electrical communication therebetween. The battery connection terminals are configured to electrically communicate with the output device to discharge the battery pack assembly and drive the vehicle, and independently, to electrically communicate with a charger to charge the battery pack assembly. A DC-DC converter is connected to the first cell set and to the second cell set and is configured to provide dynamic energy distribution between the first and second cell sets. A controller controls the one or more switches and the DC-DC converter. The controller is configured to determine an operating strategy of the battery pack assembly, and to place the first cell set, the second cell set, or both the first and second cell sets in electrical communication with the battery connection terminals in response to the operating strategy of the battery pack assembly.

In some embodiments, the operating strategy includes a charging strategy. The charging strategy includes DCFC the second cell set while the DC-DC converter distributes energy to the first cell set, or DCFC the first cell set while the DC-DC converter distributes energy to the second cell set, or charging the first and second cell sets simultaneously toward a fully charged SOC without DCFC operation.

In some embodiments, the operating strategy includes a discharging strategy. The discharging strategy includes optionally distributing energy between the first and second cell sets via the DC-DC converter, and discharging the first cell set to drive the vehicle while the second cell set is disconnected from the battery connection terminals, or discharging the second cell set to drive the vehicle while the first cell set is disconnected from the battery connection terminals, or discharging the first and second cell set to drive the vehicle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 illustrates a schematic view of a vehicle that includes an electrical system and an output device in accordance with an exemplary embodiment.

FIG. 2 illustrates a schematic view of a portion of an electrical system including a battery pack assembly, switches, and a DC-DC converter in accordance with an exemplary embodiment.

FIG. 3A is a graphical representation of an operating strategy for direct current fast charging (DCFC) of an electrical system in accordance with an exemplary embodiment.

FIG. 3B is a graphical representation of an operating strategy for DCFC of an electrical system in accordance with an exemplary embodiment.

FIG. 3C is a graphical representation of a fast charging performance comparison of two different charging scenarios of an electrical system in accordance with an exemplary embodiment.

FIG. 4 is a graphical representation of an operating strategy for a discharging strategy of an electrical system in accordance with an exemplary embodiment.

FIG. 5 illustrates a schematic view of a portion of an electrical system including a battery pack assembly, switches, and a DC-DC converter in accordance with an exemplary embodiment.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

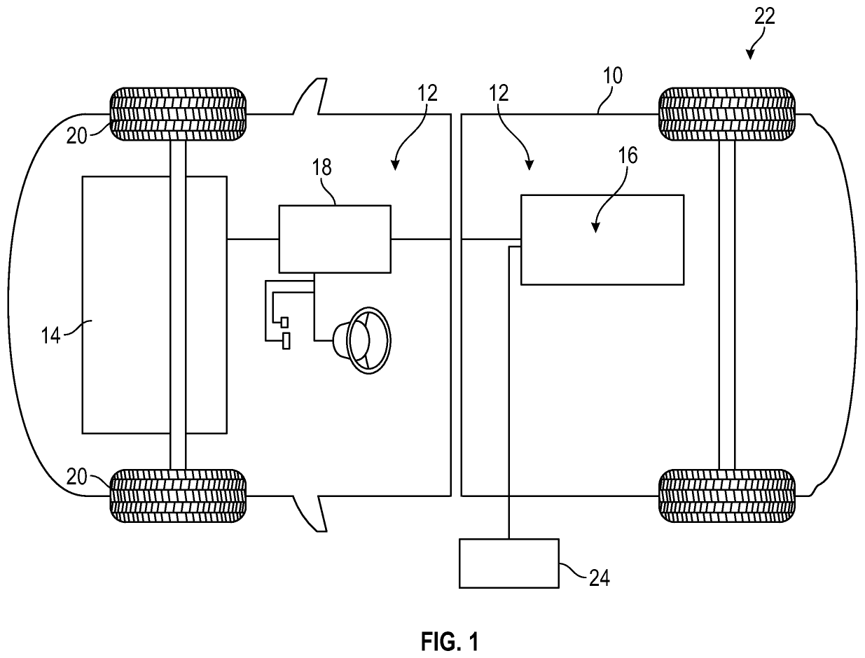

Referring to the drawings, like reference numerals correspond to like or similar components throughout the several figures. FIG. 1 illustrates a vehicle 10 that includes an electrical system 12 and an output device 14 in accordance with an exemplary embodiment. As illustrated, the vehicle 10 is a terrestrial electric vehicle (EV).

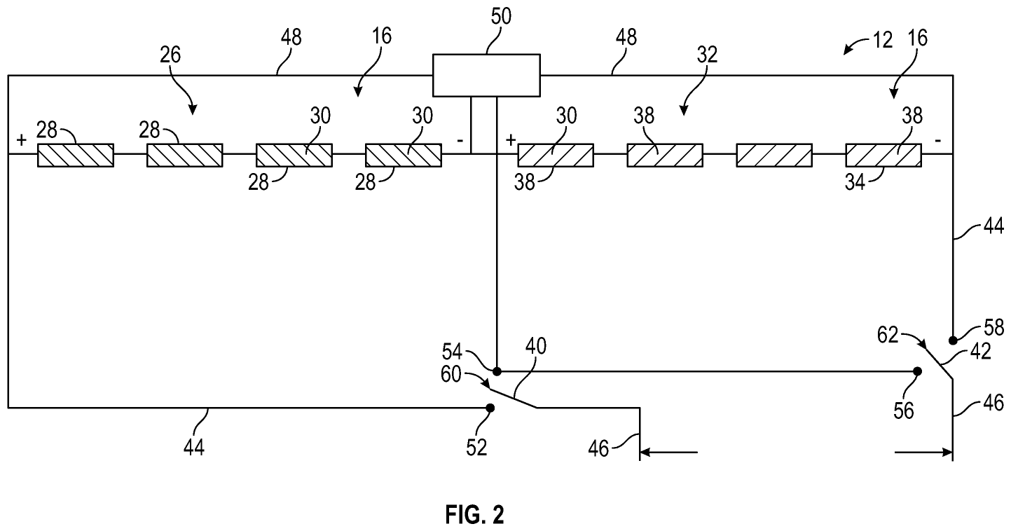

FIG. 2 illustrates a schematic view of a portion of the electrical system 12 in accordance with an exemplary embodiment. Referring to FIGS. 1-2, the electrical system 12 includes a rechargeable energy storage system (RESS), referred to herein as a “battery pack assembly” 16 and a controller 18. The battery pack assembly 16, the controller 18, and the output device 14 are installed in the vehicle and are in communication with each other. As will be discussed in further detail below, the battery pack assembly 16 is configured to generate and store electrical energy through electro-chemical reactions for supplying the electrical energy to the output device 14 to provide power to the vehicle 10 during use, e.g., to provide torque to wheels 20 to move the vehicle 10 along a road 22. Further and as illustrated, the battery pack assembly 16 is rechargeable via an external charger 24, for example, at a charging station or the like.

The controller 18 is programmable and may include a central processing unit (CPU) that regulates various functions of the vehicle 10 including the output device 14 and/or the battery pack assembly 16. In an exemplary embodiment, the controller 18 includes a processor and tangible, non-transitory memory, which includes instructions for operation of vehicle 10 including the output device 14 and the battery pack assembly 16 programmed therein. In one or more embodiments, the controller 18 includes a battery management system (BMS) that controls or otherwise manages the operation of the battery pack assembly 16. The memory may be an appropriate recordable medium that participates in providing computer-readable data or process instructions. Such a recordable medium may take many forms, including, but not limited to, non-volatile media and volatile media.

Non-volatile media for the controller module 16 may include, for example, optical or magnetic disks and other persistent memory. Volatile media may include, for example, dynamic random access memory (DRAM), which may constitute a main memory. Such instructions may be transmitted by one or more transmission medium(s), including coaxial cables, copper wire and fiber optics, including the wires that comprise a system bus coupled to a processor of a computer, or via a wireless connection.

Memory of the controller 18 may also include a flexible disk, hard disk, magnetic tape, another magnetic medium, a CD-ROM, DVD, another optical medium, etc. The controller 18 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 18 or accessible thereby, including, but not limited to predictive algorithms, algorithms for determining various operating strategies for controlling operation of the battery pack assembly 16, or the like, may be stored in the memory and automatically executed to provide the required functionality of the vehicle 10 including the output device 14 and the battery pack assembly 16.

As illustrated in FIG. 2, the battery pack assembly 16 includes a cell set 26 (e.g., first cell set) having a plurality of energy storage cells 28 and a cell set 32 (e.g., second cell set) having a plurality of energy storage cells 34. As will be discussed in further detail below, the energy storage cells 28 include or contain a battery chemistry 30 and the energy storage cells 34 include or contain a battery chemistry 38 that is different than the battery chemistry 30.

The electrical system 12 further includes switches 40 and 42 that are disposed along the bus 44 that is in electrical communication with the cell sets 26 and 32. The switches 40 and 42 are configured to selectively connect the cell sets 26 and 32 in series with the battery connection terminals 46, which are in electrical communication with either the output device 14 (load) or the charger 24, depending on whether the cell sets 26 and 32 are being discharged or charged, respectively, for electrical communication therebetween. As will be discussed in further detail below, a DC-DC converter 50 is disposed along bus 48 and is connected to the cell sets 26 and 32 to provide dynamic energy distribution (e.g., energy distribution or transfer for one cell set 26 or 32 to the other 32 or 26) between the cell sets 26 and 32.

In an exemplary embodiment, the controller 18 controls the switches 40 and 42 and the DC-DC converter 50. Further, the controller 18 is operative to determine an operating strategy of the battery pack assembly 16 and to place the cell set 26, the second cell set 32, or both the cell sets 26 and 32 in electrical communication with the battery connection terminals 46 in response to the operating strategy of the battery pack assembly 16.

In an exemplary embodiment, the battery chemistry 30 of the energy storage cells 28 is or otherwise include a high energy density battery chemistry while the battery chemistry 38 of the energy storage cells 34 is or otherwise includes a high charging and discharging rate battery chemistry. In an exemplary embodiment, the high energy density battery chemistry is or includes a lithium ion battery chemistry that includes a cathode that is formed of or includes nickel, cobalt, and manganese (NCM battery chemistry). In an exemplary embodiment, the high charging and discharging rate battery chemistry includes a sodium ion battery chemistry (sodium battery chemistry).

The switches 40 and 42 are positionally controlled by the controller 18. The switches 40 and 42 are configured for electrical communication with the cell sets 26 and 32. As illustrated, the switch 40 has a first switch A position 52 and a second switch A position 54. Likewise, the switch 42 has a first switch B position 56 and a second switch B position 58. In an exemplary embodiment, when the controller 18 positions the switch 40 in the first switch A position 52 and the switch 42 in the first switch B position 56, the cell set 26 is in electrical communication with the battery connection terminals 46 while the cell set 32 is disconnected from the battery connection terminals 46. Further, when the controller 18 positions the switch 40 in the first switch A position 52 and the switch 42 in the second switch B position 58, the cell set 26 and the cell set 32 are connected in series and are in electrical communication with battery connection terminals 46. Additionally, when the controller 18 positions the switch 40 in the second switch A position 54 and the switch 42 in the second switch B position 58, the cell set 32 is in electrical communication with the battery connection terminals 46 while the cell set 26 is disconnected from the battery connection terminals 46.

In an exemplary embodiment, the electrical system 10 is configured to disconnect the battery pack assembly 16 to the battery connection terminals 46. As illustrated, the switch 40 further has a switch A disconnect position 60 and the switch 42 further has a switch B disconnect position 62. In an exemplary embodiment, when the controller 18 positions the switch 40 in the switch A disconnect position 60 and the switch 42 in the switch B disconnect position 62, the battery pack assembly 16 is disconnected from the battery connection terminals 46.

In an exemplary embodiment, the illustrated electrical system 12, which includes different battery chemistries, provides improved efficiencies, increased charging and discharging performance, with greater capacity and enhanced performance based upon various operating strategies that leverage the advantages of each of the distinct battery chemistries under various scenarios. The following are some non-limiting examples of various operating strategies for the electrical system 12.

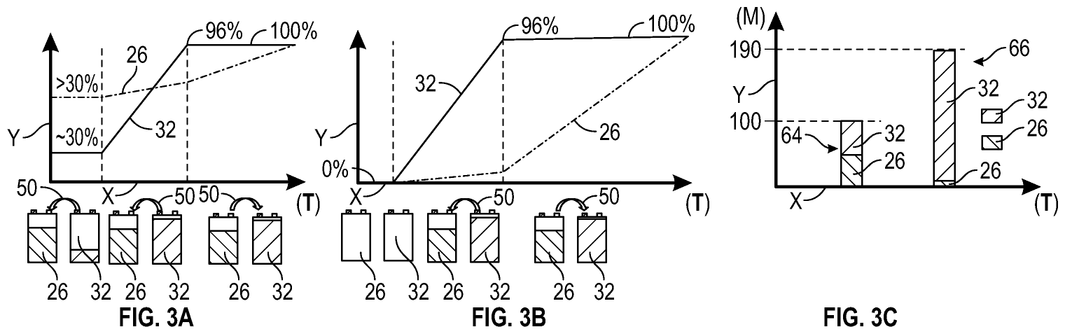

FIG. 3A is a graphical representation of an operating strategy for direct current fast charging (DCFC) of electrical system 12 in which the X-axis represents time (T) and the Y-axis represents state of charge (SOC) in accordance with an exemplary embodiment. Referring to FIGS. 1-3A, in an exemplary embodiment, the operating strategy includes a relatively high energy state of charge (SOC) charging strategy for DCFC a battery pack assembly 16 for when the battery pack assembly 16, and more particularly for when the cell set 32 has a relatively high SOC at or above a predetermined SOC threshold. In an exemplary embodiment, the predetermined threshold is from about 25% to about 35%, for example about 30%.

In one or more embodiments, the relatively high energy SOC charging strategy includes DCFC the cell set 32 towards a nearly fully charged predetermined SOC threshold while the DC-DC converter 50 distributes energy from the 32 to the cell set 26. In an exemplary embodiment, the nearly fully charged predetermined SOC threshold is from about 94% to about 98%, for example about 96%. In one or more embodiments, if or when the cell set 32 reaches the nearly fully charged predetermined SOC threshold, then the cell set 26 is DCFC toward a fully charged SOC (e.g., about 100%) while the DC-DC converter 50 distributes energy from the cell set 26 to the cell set 32 to charge both the cell sets 26 and 32 toward the fully SOC.

FIG. 3B is a graphical representation of an operating strategy for DCFC of the electrical system 12 in which the X-axis represents time (T) and the Y-axis represents state of charge (SOC) in accordance with an exemplary embodiment. Referring to FIGS. 1-2 and 3B, in an exemplary embodiment, the operating strategy includes a relatively low energy SOC charging strategy for when the battery pack assembly 16, and more particularly for when the cell set 32 (or both cell sets 26 and 32) has a SOC at or below a nearly zero predetermined SOC threshold. In an exemplary embodiment, the nearly zero predetermined SOC threshold is from about 0% to about 10%, for example about 0%.

In one or more embodiments, the relatively low energy SOC charging strategy includes DCFC the cell set 32 toward a nearly fully charged predetermined SOC threshold while the DC-DC converter 50 distributes energy to the cell set 26. In one or more embodiments, if or when the cell set reaches 32 the nearly fully charged predetermined SOC threshold, then the cell set 26 is DCFC toward a fully charged SOC while the DC-DC converter 50 distributes energy from the cell set 26 to the cell set 32 to charge both the cell sets 26 and 32 toward the fully charged SOC (e.g., about 100%). In an exemplary embodiment, the nearly fully charged predetermined SOC threshold is from about 94% to about 98%, for example about 96%. Alternatively, the cell sets 26 and 32 may be simultaneously charged toward the fully charged SOC, for example, without DCFC operation.

FIG. 3C is a graphical representation of a fast charging performance comparison of two different charging scenarios of an electrical system in which the Y-axis represents miles (M) drivable based on the charge scenario(s) in accordance with an exemplary embodiment. Bar 64 represents charging the cell sets 26 and 32 (e.g., which contain the NCM battery chemistry and sodium battery chemistry, respectively) simultaneously, for example, for 10 minutes of DCFC charging. Bar 66 represents charging exclusively the cell set 32 (e.g., which contains the sodium battery chemistry) for 10 minutes of DCFC charging. As illustrated, bar 66 represents 1.9 times (190 miles vs. 100 miles) bar 64 for resulting driving distance for the same amount (e.g., 10 minutes) and type of charging (e.g., DCFC).

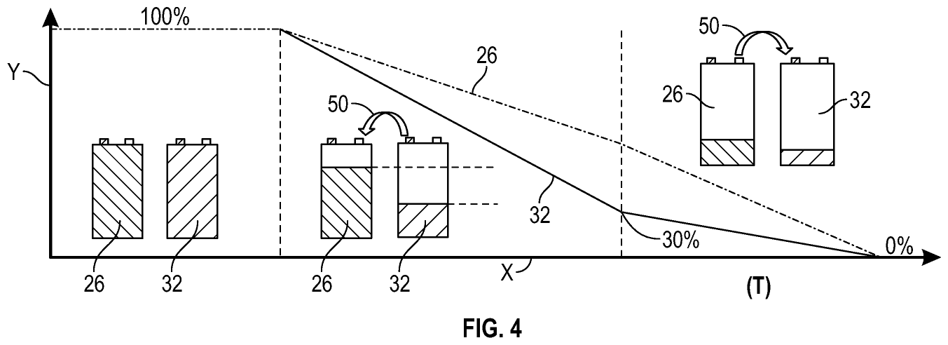

FIG. 4 is a graphical representation of an operating strategy for a discharging strategy of the electrical system 12 in which the X-axis represents time (T) and the Y-axis represents state of charge (SOC) in accordance with an exemplary embodiment. Referring to FIGS. 1-2 and 4, in an exemplary embodiment, the operating strategy includes a relatively high SOC discharging strategy for when the battery pack assembly 16, and more particularly when the cell set 32 (or both cell sets 26 and 32) has a SOC (e.g., from about 40% to about 100%, for example nearly fully charged) above a predetermined SOC threshold. In an exemplary embodiment, the predetermined SOC threshold is from about 25% to about 35%, for example about 30%. In an exemplary embodiment, the relatively high SOC discharging strategy includes discharging the cell sets 26 and 32 while the DC-DC converter 50 distributes energy from the cell set 32 to the cell set 26 until the cell set 32 is at or below the predetermined SOC threshold. If or when the cell set 32 is at or below the predetermined SOC threshold, the cell sets 26 and 32 are discharged while the DC-DC converter 50 distributes energy from the cell set 26 to the cell set 32 to fully discharge the cell sets 26 and 32.

Referring again to FIGS. 1-2, in an exemplary embodiment, the operating strategy includes a relatively low temperature discharging strategy for when the battery pack assembly is at a predetermined low temperature threshold. In an exemplary embodiment, the predetermined low temperature threshold is about −20° C. or less, for example from about −35° C. to about −20° C. In one or more embodiments, the relatively low temperature discharging strategy includes discharging the cell set 32 while the cell set 26 is disconnected from the battery connection terminals and the DC-DC converter 50 distributes energy to heat the cell set 26 to a temperature above the predetermined low temperature threshold. When battery pack assembly 16 is at or above a temperature (e.g., about 0° C. or greater) above the predetermined low temperature threshold, the cell sets 26 and 32 are then simultaneously discharged.

In an exemplary embodiment, the operating strategy includes a relatively low DC voltage condition driving cycle discharging strategy, for example, utilized during city driving. The relatively low voltage condition driving cycle discharging strategy includes discharging the cell set 26 while the cell set 32 is disconnected from the battery connection terminals 46. In an alternative embodiment, the relatively low voltage condition driving cycle discharging strategy includes discharging the cell set 32 while the cell set 26 is disconnected from the battery connection terminals 46.

In an exemplary embodiment, the operating strategy includes a relatively high DC voltage condition driving cycle discharging strategy, for example, utilized during highway driving. The relatively high DC voltage condition driving cycle discharging strategy includes discharging the cell sets 26 and 32 simultaneously.

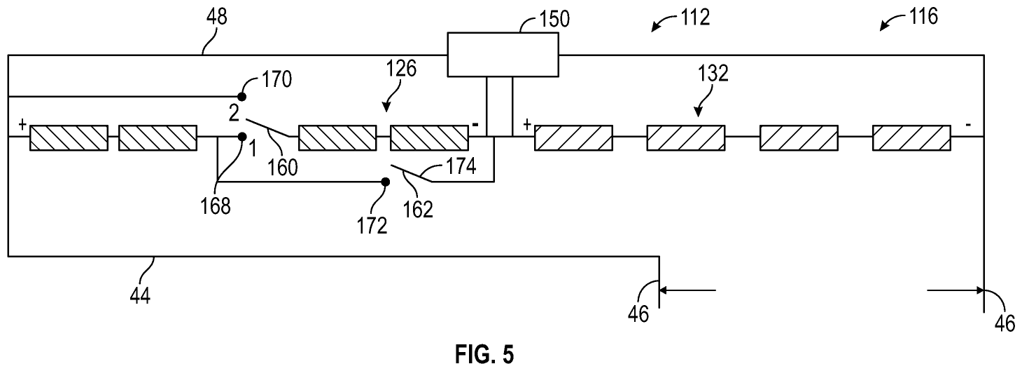

FIG. 5 illustrates a schematic view of a portion of an electrical system 112 including a battery pack assembly 116, switches 160 and 162, and the DC-DC converter 150 in accordance with an exemplary embodiment. The electrical system 112 including the battery pack assembly 116, cell sets 126 and 132, the DC-DC converter 150, and battery connection terminals 46 is similarly configured to the electrical system 12 including the including the battery pack assembly 16, cell sets 26 and 32, the DC-DC converter 50, and battery connection terminals 46 as illustrated in FIG. 2 but with the exception that the switches 160 and 162 are arranged for electrical communication with the cell set 126. In an exemplary embodiment, the switches 160 and 162 (e.g., are positionally controlled) and the DC-DC converter 150 are controlled by the controller 18 to place the cell sets 126 and/or 132 in communication with the battery connection terminals 46 in response to the operating strategy/strategies as discussed above.

In an exemplary embodiment, the switch 160 has a first switch A position 168 and a second switch A position 170, and the switch 162 has a first switch B position 172 and a switch B disconnect position 174. When the controller 18 positions the switch 160 in the first switch A position 168 and the switch 162 in the switch B disconnect position 174, the cell set 126 and the cell set 132 are connected in series and are in electrical communication with battery connection terminals 46. Further, in an exemplary embodiment when the controller 18 positions the switch 126 in the second switch A position 170 and the switch 132 in the first switch B position 172, the cell set 126 is in parallel and connected to the cell set 132 for electrical communication with the battery connection terminals 46.

In an exemplary embodiment, advantageously, the parallel connection of the cell set 126 with the cell set 132, which thereby matches the C-rate charging of the cell sets 126 and 132, helps to improve fast charging capability. In an exemplary embodiment, advantageously, the series connection of the cell set 126 during discharging helps to ensure that both cell sets 126 and 132 are depleted simultaneously. In an exemplary embodiment, the DC-DC converter 50 may be optional, that is, it may be eliminated for some applications, and included for others to provide dynamic energy distribution between the cell sets 126 and 132 in response to the operating strategy of the battery pack assembly 116.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An electrical system comprising:
a battery pack assembly comprising:
a first cell set having a first plurality of energy storage cells that include a first battery chemistry; and
a second cell set having a second plurality of energy storage cells that include a second battery chemistry that is different than the first battery chemistry;
one or more switches configured to selectively connect the first cell set and the second cell set in series with battery connection terminals for electrical communication therebetween;
a DC-DC converter connected to the first cell set and to the second cell set and configured to provide dynamic energy distribution between the first and second cell sets; and
a controller that controls the one or more switches and the DC-DC converter and that is configured to:
determine an operating strategy of the battery pack assembly; and
place the first cell set, the second cell set, or both the first and second cell sets in electrical communication with the battery connection terminals in response to the operating strategy of the battery pack assembly.

2. The electrical system of claim 1, wherein the first battery chemistry comprises a high energy density battery chemistry and the second battery chemistry comprises a high charging and discharging rate battery chemistry.

3. The electrical system of claim 2, wherein the high energy density battery chemistry comprises a lithium ion battery chemistry that includes a cathode comprising nickel, cobalt, and manganese (NCM battery chemistry), and wherein the high charging and discharging rate battery chemistry comprises a sodium ion battery chemistry (sodium battery chemistry).

4. The electrical system of claim 1, wherein the one or more switches comprises a first switch and a second switch that are positionally controlled by the controller and configured for electrical communication with the first and second cell sets, wherein the first switch has a first switch A position and a second switch A position, and the second switch has a first switch B position and a second switch B position, wherein when the controller positions the first switch in the first switch A position and the second switch in the first switch B position, the first cell set is in electrical communication with the battery connection terminals while the second cell set is disconnected from the battery connection terminals, wherein when the controller positions the first switch in the first switch A position and the second switch in the second switch B position, the first cell set and the second cell set in series are in electrical communication with battery connection terminals, and wherein when the controller positions the first switch in the second switch A position and the second switch in the second switch B position, the second cell set is in electrical communication with the battery connection terminals while the first cell set is disconnected from the battery connection terminals.

5. The electrical system of claim 4, wherein the first switch further has a switch A disconnect position and the second switch further has a switch B disconnect position, and wherein when the controller positions the first switch in the switch A disconnect position and the second switch in the switch B disconnect position, the battery pack assembly is disconnected from the battery connection terminals.

6. The electrical system of claim 1, wherein the one or more switches comprises a first switch and a second switch that are positionally controlled by the controller and configured for electrical communication with the first cell set, wherein the first switch has a first switch A position and a second switch A position, and the second switch has a first switch B position and a switch B disconnect position, wherein when the controller positions the first switch in the first switch A position and the second switch in the switch B disconnect position, the first cell set and the second cell set in series are in electrical communication with battery connection terminals, and wherein when the controller positions the first switch in the second switch A position and the second switch in the first switch B position, the first cell set is in parallel and connected with the second cell set for electrical communication with the battery connection terminals.

7. The electrical system of claim 1, wherein the operating strategy comprises a relatively high energy state of charge (SOC) charging strategy for direct current fast charging (DCFC) for when the second cell set has a SOC at or above a predetermined SOC threshold, wherein the relatively high energy SOC charging strategy comprises DCFC the second cell set toward a nearly fully charged predetermined SOC threshold while the DC-DC converter distributes energy to the first cell set, and wherein if the second cell set reaches the nearly fully charged predetermined SOC threshold, then the first cell set is DCFC toward a fully charged SOC while the DC-DC converter distributes energy to the second cell set to charge both the first and second cell sets toward the fully SOC.

8. The electrical system of claim 7, wherein the predetermined SOC threshold is from about 25% to about 35%, and wherein the nearly fully charged predetermined SOC threshold is from about 94% to about 98%.

9. The electrical system of claim 1, wherein the operating strategy comprises a relatively low energy SOC charging strategy for when the second cell set has a SOC at or below a nearly zero predetermined SOC threshold, wherein the relatively low energy SOC charging strategy comprises:
DCFC the second cell set toward a nearly fully charged predetermined SOC threshold while the DC-DC converter distributes energy to the first cell set, and wherein if the second cell set reaches the nearly fully charged predetermined SOC threshold, then the first cell set is DCFC toward a fully charged SOC while the DC-DC converter distributes energy to the second cell set to charge both the first and second cell sets toward the fully charged SOC; or
charging the first and second cell sets simultaneously toward the fully charged SOC without DCFC operation.

10. The electrical system of claim 9, wherein the nearly zero predetermined SOC threshold is from about 0% to about 10%, and wherein the nearly fully charged predetermined SOC threshold is from about 94% to about 98%.

11. The electrical system of claim 1, wherein the operating strategy comprises a relatively high SOC discharging strategy for when the second cell set has a SOC above a predetermined SOC threshold, wherein the relatively high SOC discharging strategy comprises discharging the first and second cell sets while the DC-DC converter distributes energy from the second cell set to the first cell set until the second cell set is at or below the predetermined SOC threshold, and wherein if the second cell set is at or below the predetermined SOC threshold, discharging the first and second cell sets while the DC-DC converter distributes energy from the first cell set to the second cell set to fully discharge the first and second cell sets.

12. The electrical system of claim 11, wherein the predetermined SOC threshold is from about 25% to about 35%.

13. The electrical system of claim 1, wherein the operating strategy comprises a relatively low temperature discharging strategy for when the battery pack assembly is at a predetermined low temperature threshold, wherein the relatively low temperature discharging strategy comprises discharging the second cell set while the first cell set is disconnected from the battery connection terminals and the DC-DC converter distributes energy to heat the first cell set to a temperature above the predetermined low temperature threshold, and wherein when the battery pack assembly is at or above the temperature above the predetermined low temperature threshold, the first and second cell sets are simultaneously discharging.

14. The electrical system of claim 13, wherein the predetermined low temperature threshold is from about −35° C. to about −20° C.

15. The electrical system of claim 1, wherein the operating strategy comprises a relatively low DC voltage condition driving cycle discharging strategy that comprises:
discharging the first cell set while the second cell set is disconnected from the battery connection terminals; or
discharging the second cell set while the first cell set is disconnected from the battery connection terminals.

16. The electrical system of claim 1, wherein the operating strategy comprises a relatively high DC voltage condition driving cycle discharging strategy that comprises discharging the first and second cell sets.

17. A method of operating an electrical system, the method comprising:
determining an operating strategy of a battery pack assembly, wherein the battery pack assembly comprises:
a first cell set having a first plurality of energy storage cells that include a first battery chemistry; and
a second cell set having a second plurality of energy storage cells that include a second battery chemistry that is different than the first battery chemistry;
placing the first cell set, the second cell set, or both the first and second cell sets in series in electrical communication with battery connection terminals in response to the operating strategy of the battery pack assembly; and
optionally providing dynamic energy distribution between the first and second cell sets in response to the operating strategy of the battery pack assembly.

18. A vehicle comprising:
an output device; and
an electrical system configured to provide electrical energy to the output device, the electrical system comprising:
a battery pack assembly comprising:
a first cell set having a first plurality of energy storage cells that include a first battery chemistry; and
a second cell set having a second plurality of energy storage cells that include a second battery chemistry that is different than the first battery chemistry;
one or more switches configured to selectively connect the first cell set and the second cell set in series with battery connection terminals for electrical communication therebetween, wherein the battery connection terminals are configured to electrically communicate with the output device to discharge the battery pack assembly and drive the vehicle, and independently, to electrically communicate with a charger to charge the battery pack assembly;
a DC-DC converter connected to the first cell set and to the second cell set and configured to provide dynamic energy distribution between the first and second cell sets; and
a controller that controls the one or more switches and the DC-DC converter and that is configured to:
determine an operating strategy of the battery pack assembly; and
place the first cell set, the second cell set, or both the first and second cell sets in electrical communication with the battery connection terminals in response to the operating strategy of the battery pack assembly.

19. The vehicle of claim 18, wherein the operating strategy comprises a charging strategy comprising:
DCFC the second cell set while the DC-DC converter distributes energy to the first cell set; or
DCFC the first cell set while the DC-DC converter distributes energy to the second cell set; or
charging the first and second cell sets simultaneously toward a fully charged SOC without DCFC operation.

20. The vehicle of claim 18, wherein the operating strategy comprises a discharging strategy comprising:
optionally distributing energy between the first and second cell sets via the DC-DC converter; and
discharging the first cell set to drive the vehicle while the second cell set is disconnected from the battery connection terminals; or
discharging the second cell set to drive the vehicle while the first cell set is disconnected from the battery connection terminals; or
discharging the first and second cell set to drive the vehicle.
